(19) United States
(12) Patent Application Publication
(10) Pub. No.: US 2007/0085236 A1
(43) Pub. Date: Apr. 19, 2007

(54) Process for making solid surface counter tops

(76) Inventor: Donald R. Horn, Goodyear, AZ (US)

Correspondence Address: JAMES RAY & ASSOCIATES, 2640 PITCAIRN ROAD, MONROEVILLE, PA, 15146, US

(21) Appl. No.: 11/252,330

(22) Filed: Oct. 17, 2005

(51) Int. Cl. B29C 70/44

(52) U.S. Cl. 264/258; 264/324

(57) ABSTRACT

A process for making a lightweight composite for use in at least one of a counter top, shower surround, bath tub, sink and various other preselected commercial products. The process comprises the steps of forming a surface coat having a predetermined thickness and a step of laying cotton flock and low profile tooling resin into preselected areas of the surface coat adjacent a bottom surface thereof. There is a step of applying a layer of fiber reinforcement and low profile tooling resin onto at least the cotton flock and a step of applying a resin coat to such bottom surface of the cotton flock and the surface coat. There is a step of adhering a surface of a core member to the surface of the resin coat and a step of laminating a layer of fiber reinforced, low profile tooling resin onto a radially opposed surface of the core member to form a composite. Another step is applying a weight to the composite to keep the core member from warping during curing. There is a step of curing the composite material and a step of removing such mold from the cured composite material.

### CROSS-REFERENCE TO RELATED APPLICATIONS

The invention taught in this patent application is closely related to the following co-pending U.S. patent applications, “Surface Coat Formula for Solid Surfaces Composites” and “A Solid Surface Composite”. These co-pending applications numbered Ser. No. ______ and Ser. No. ______ were filed on Jul. ______, 2005 and Jul. ______, 2005. Further, the teachings of the above mentioned applications are incorporated herein by reference hereto.

### FIELD OF THE INVENTION

The present invention relates, in general, to a process for making counter tops, and more specifically, the present invention relates to a new process for making a lightweight composite material for use as counter tops in such areas as kitchens and bathrooms.

### BACKGROUND OF THE INVENTION

There are many materials that are used to form counter tops that can be used in such areas as the kitchen and bathroom. Different materials have been used through the years to form tops that are both attractive and can withstand the constant usage that the tops encounter. This is particularly true with the kitchen counter top.

One problem that has generally plagued makers of counter tops and installers has been to make a good seal in the corner areas and the back splashes and also any side splashes that may be used on the counter tops. This is primarily because corners, back splashes and side splashes are not normally seamless. Thus, there tends to be unsightly corners and back and side splashes that have to glued onto the counter top providing a point where moisture can compromise the integrity of the top.

Another problem area that has been encountered is the union between the counter top and the sink because sinks are not normally integrated into the counter top. Still another problem concerns the weight that is involved with most counter tops, since most counter tops quite heavy. This, for the most part, creates a problem for the installer. Thus, it would be desirable if there were a counter top that would eliminate the above problems.

### SUMMARY OF THE INVENTION

The present invention provides a process for making a lightweight composite for use in at least one of a counter top, shower surround, bath tub, sink and various other preselected commercial products. The process comprises the steps of forming a surface coat having a predetermined thickness onto a waxed mold and a step of laying cotton flock and low profile tooling resin into preselected areas of the surface coat adjacent a bottom surface thereof. There is a step of applying a layer of fiber reinforcement and low profile tooling resin onto at least the cotton flock and a step of applying a resin coat to such bottom surface of the cotton flock and the surface coat. There is a step of adhering a surface of a core member to the surface of the resin coat and a step of laminating a layer of fiber reinforced, low profile tooling resin onto a radially opposed surface of the core member to form a composite. Another step is applying a weight to the composite to keep the core member from warping during a curing process. There is a step of curing the composite material and a step of removing such mold from the cured composite material.

### OBJECTS OF THE INVENTION

It is, therefore, one of the primary objects of the present invention to provide a process for making a lightweight solid surface composite that can be used for kitchen and bathroom counter tops, shower surrounds, bathtubs, sinks and various other similar applications.

Another object of the present invention is to provide a process for making a lightweight solid surface composite in which back and side splashes are seamless.

Still another object of the present invention is to provide a process for making a lightweight solid surface composite in which back and side splashes are integrated into the counter top surface.

Yet another object of the present invention is to provide a process for making a lightweight solid surface composite in which the corners are seamless.

Another object of the present invention is to provide a process for making a lightweight solid surface composite in which the surface coat is formed by atomized casting rather than being poured.

It is still another object of the present invention to provide a process for making a lightweight solid surface composite in which the product contains particle board and corrugated cardboard to increase tensile strength.

Yet, it is still another object of the present invention to provide a process for making a lightweight solid surface composite in which the product weighs only about 20% of the weight of presently used counter tops.

These and various other objects and advantages of this invention will become apparent after a full reading of the following detailed description, particularly, when read in conjunction with the attached drawings as described below and the appended claims.

### BRIEF DESCRIPTION OF THE PRESENTLY PREFERRED AND ALTERNATE EMBODIMENTS OF THE INVENTION

The present invention provides a process for making a lightweight composite for use as counter tops, shower surrounds, bath tubs, sinks and various other commercial uses.

The process comprises the steps of forming a surface coat having a predetermined thickness onto a waxed mold. Such surface coat includes a densified resin and methyl methacrylate.

This is followed by the step of laying cotton flock and low profile tooling resin into preselected areas of the surface coat adjacent a bottom surface thereof. It is presently preferred that such preselected areas include at least one of the radius and corners for providing reinforcement to the surface coat. It is preferred that such cotton flock be applied as a putty and that such low profile tooling resin is a polyester resin.

There is a step of applying a layer of fiber reinforcement and low profile tooling resin onto at least the cotton flock. It is presently preferred that such fiber reinforcement be in the form of fiberglass and it is preferred that such fiberglass be chopped fiberglass. It is also preferred that such low profile tooling resin be hand laminated onto the cotton flock.

There is a step of applying (laying down) a resin coat to the bottom surface of the cotton flock and the surface coat, followed by a step adhering a surface of a core member to a surface of the resin coat. It is presently preferred that such core member consist of particle board or corrugated cardboard.

There is a step of laminating a final layer of fiber reinforced, low profile tooling resin onto a radially opposed surface of such core member to form a composite. Again, it is presently preferred that such fiber reinforced, low profile tooling resin is hand laminated onto the core and that such resin is a polyester.

Another step in the process is applying a weight to the composite to keep the core member from warping during a curing process. The particle board or the corrugated cardboard could possibly warp during curing if a weight is not applied to keep it straight.

There is a step of curing the composite material and finally there is a step of removing such mold from the cured composite material. It is presently preferred that such curing be done at ambient temperatures. This would included temperatures ranging from approximately 50 degrees to about 100 degrees Fahrenheit. Such curing can take approximately 4 or 5 hours at such ambient temperatures.

It is also presently preferred that such composite be polished to provide the composite with a high gloss finish after the composite is removed from the mold after being cured.

In a presently preferred embodiment of the invention such surface coat is applied by casting and that such casting is by atomizing said surface coat. Thus, it is preferred that the surface coat be sprayed on rather than being poured. It is further preferred that such surface coat include a densified resin and that such densified resin is a polyester and also that such surface coat include methyl methacrylate.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. A process for making a lightweight composite for use in at least one of a counter top, shower surround, bath tub, sink and various other preselected commercial products, said process comprising the steps of:
(a) forming a surface coat having a predetermined thickness;
(b) laying cotton flock and low profile tooling resin onto preselected areas of said surface coat adjacent a bottom surface thereof;
(c) applying a layer of fiber reinforcement and low profile tooling resin onto at least said cotton flock;
(d) applying a resin coat to said bottom surface of said cotton flock and said surface coat;
(e) adhering a surface of a core member to a surface of said resin coat;
(f) laminating a layer of fiber reinforced, low profile tooling resin onto a radially opposed surface of said core member to form a composite;
(g) applying a weight to said composite to keep said core member from warping during a curing process;
(h) curing said composite material; and
(i) removing said mold from said cured composite material.

2. The process for making a lightweight composite, according to claim 1, wherein said process further includes a step of polishing said composite to a high gloss finish.

3. The process for making a lightweight composite, according to claim 1, wherein said process further includes in step (a) applying said surface coat by casting.

4. The process for making a lightweight composite, according to claim 3, wherein said casting is by atomizing said surface coat.

5. The process for making a lightweight composite, according to claim 1, wherein said core member adhered to said resin coat in step (e) is selected from at least one of particle board and corrugated cardboard.

6. The process for making a lightweight composite, according to claim 1, wherein said fiber reinforcement applied in step 8) is fiberglass.

7. The process for making a lightweight composite, according to claim 6, wherein said fiberglass is chopped fiberglass.

8. The process for making a lightweight composite, according to claim 1, wherein said surface coat applied in step (a) includes a densified resin.

9. The process for making a lightweight composite, according to claim 1, wherein in step (b) said predetermined areas of said surface coat include at least one of radius and corners.

10. The process for making a lightweight composite, according to claim 9, wherein said predetermined areas of said surface coat include radius and corners.

11. The process for making a lightweight composite, according to claim 1, wherein said surface coat in step (a) is formed on a wax mold.

12. The process for making a lightweight composite, according to claim 1, wherein said curing in step (h) is done at ambient temperatures.
